(19) United States
(12) Patent Application Publication
(10) Pub. No.: US 2021/0169057 A1
(43) Pub. Date: Jun. 10, 2021

(54) MULTI-KITE APPARATUS FOR USE WITH BOTTOM TRAWLS

(71) Applicant: Fisheries and Marine Institute of the Memorial University, St. John's (CA)

(72) Inventors: Paul WINGER, Portugal Cove (CA); George LEGGE, Paradise (CA); Philip WALSH, St. John's (CA); Harold DELOUCHE, Paradise (CA); Tara PERRY, Paradise (CA); Alex GARDNER, St. John's (CA); Chanwoo BAE, St. John's (CA)

(21) Appl. No.: 16/772,042

(22) PCT Filed: Dec. 12, 2018
(86) PCT No.: PCT/CA2018/051584

§ 371 Date: Jun. 11, 2020

(30) Foreign Application Priority Data
Dec. 13, 2017 (CA) 2988743

(51) Int. Cl. A01K 73/045

(52) U.S. Cl. CPC A01K 73/045

(57) ABSTRACT

An apparatus for spreading the mouth of a bottom trawl comprising an array of flexible foil shaped kites that is capable of being mounted proximate to a wing of the bottom trawl, and wherein each of the kites in the array of flexible foil shaped kites has the same chord length and comprises: a middle kite foil section having an outer profile shape (preferably substantially a NACA 5319 shape) that is capable of assisting in spreading the mouth of the bottom trawl when in use, and having pockets extending longitudinally therethrough that house rope or wire of varying diameter, and a first and second endplate attached at each of a first and second distal end of the middle kite foil section respectively for maintaining a desired rigidity of the kite foil section, said first and second endplates having openings there through in communication with the pockets of the middle kite foil section, such that the rope or wire of varying diameter securely extends through said openings in the first and second endplate.

### FIELD OF THE INVENTION

The present invention relates to an environmentally-friendly apparatus for spreading the mouth of a bottom trawl. More particularly, the present invention relates to an apparatus that can replace traditional trawl doors for spreading the mouth of a bottom trawl.

### BACKGROUND OF THE INVENTION

The Earth's oceans have for centuries provided human populations with what was once thought to be a virtually endless source of food. However, the impact of fishing and other human activities on the marine environment has become a growing concern.

Bottom trawling is a fishing method wherein the primary function of the forward parts of the trawl are designed to maintain contact with the seabed, provide spread to the net, and herd target species into the net. Traditional bottom trawls are spread using heavy steel doors (often weighing up to 1.5 metric tons (i.e. 1500 kg) each) with associated bridles. See FIG. 1 for a schematic drawing of a traditional bottom trawl that employs trawl doors. By design, such doors produce a horizontal spreading force through a combination of hydrodynamic and shearing forces with the seabed. Not only does this produce large sand clouds during towing, but it is known that these doors can produce negative seabed impacts, including physical alteration of the seabed, mortality of benthic animals, and suspension of sediment. Such disturbances can cause a change in species populations, species composition and species diversity, which can ultimately impact the long-term sustainability of marine food resources for human populations.

It would therefore be useful to provide an apparatus that can replace traditional trawl doors in order to overcome at least some of the shortcomings and negative impacts associated with the use of traditional trawl doors, while still being able to effectively spread a bottom trawl for fishing purposes.

### SUMMARY OF THE INVENTION

The present invention relates to an apparatus that can provide a sufficient horizontal spreading force to the mouth of a bottom trawl, while replacing traditional trawl doors with a more environmentally-friendly option that assists with lowering or minimizing negative seabed impacts, including physical alteration of the seabed, mortality of benthic animals, and suspension of sediment. Placement and orientation of the apparatus is preferably optimized to maximize hydrodynamic lift forces (i.e., horizontal spreading power) to assist in effectively spreading the mouth of the trawl horizontally, while lowering, minimizing, or even potentially negating contact and shearing forces on the seabed.

The apparatus comprises an array (i.e. at least two and preferably three or more) of flexible foil shaped kites that are mounted near the wings on each side of a bottom trawl. These arrays of kites are preferably rigged in a manner that provides optimal spacing between the individual kites as well as an optimal “angle of attack” of the array of kites that will produce sufficient horizontal spread of the net.

The foil sections of the individual kites are themselves comprised of a flexible material surrounding ropes, wires, or the like, of various diameters that are sewn and held within individual pockets of the kite foil to keep them in order and to provide the kite foil with a particular shape, while endplates at either end of the kite secure the kite foil and assist in maintaining the shape of the kite.

In particular, in one embodiment the present invention provides a flexible foil shaped kite for use in spreading the mouth of a bottom trawl, said kite comprising: a middle kite foil section having an outer profile shape that is capable of assisting in spreading the mouth of the bottom trawl when in use, and having pockets extending longitudinally therethrough that house rope or wire of varying diameter, and a first and second endplate attached at each of a first and second distal end of the middle kite foil section respectively for maintaining a desired rigidity of the kite foil section, said first and second endplates having openings therethrough in communication with the pockets of the middle kite foil section, such that the rope or wire of varying diameter securely extends through said openings in the first and second endplate. The outer profile shape of the kite foil section is preferably substantially a NACA 5314 shape, and the kite foil section is preferably comprised of vinyl. The first and second endplates are preferably comprised of steel. The flexible foil shaped kite is preferably capable of being wound with the bottom trawl onto a netdrum on a stern of a vessel, and the flexible foil shaped kite is preferably for use with bottom trawling.

In another embodiment, the present invention provides an apparatus for spreading the mouth of a bottom trawl comprising, an array of flexible foil shaped kites that is capable of being mounted proximate to a wing of the bottom trawl, and wherein each of the kites in the array of flexible foil shaped kites has the same chord length and comprises: a middle kite foil section having an outer profile shape that is capable of assisting in spreading the mouth of the bottom trawl when in use, and having pockets extending longitudinally therethrough that house rope or wire of varying diameter, and a first and second endplate attached at each of a first and second distal end of the middle kite foil section respectively for maintaining a desired rigidity of the kite foil section, said first and second endplates having openings therethrough in communication with the pockets of the middle kite foil section, such that the rope or wire of varying diameter securely extends through said openings in the first and second endplate. The outer profile shape of the kite foil sections of the kites in the array of flexible foil shaped kites are all preferably substantially of a NACA 5314 shape, and the middle kite foil section of each of the kites in the array of flexible foil shaped kites is preferably comprised of vinyl. The first and second endplates of each of the kites in the array of flexible foil shaped kites are preferably comprised of steel. The kites in the array of flexible foil shaped kites are preferably spaced apart at a distance of about 1.5 times the chord length of the kites. The kites in the array of flexible foil shaped kites are preferably oriented at a 35 degree angle of attack to the forward towing direction of the trawl. The apparatus is preferably capable of being wound with the bottom trawl onto a netdrum on a stern of a vessel, and the apparatus is preferably for use with bottom trawling.

### BRIEF DESCRIPTION OF THE DRAWINGS

The embodiment of the invention will now be described, by way of example, with reference to the accompanying drawings in which:

FIG. 1 is a representation of a prior art bottom trawl employing traditional trawl doors;

FIG. 2 is a representative diagram comparing effects on the seabed by use of a traditional bottom trawl employing trawl doors and bridles (upper drawing) to that of a bottom trawl employing flexible foil shaped kites (bottom drawing) in accordance with one embodiment of the present invention;

FIG. 3 is a representative perspective view of a bottom trawl in an open position by means of the operation of the flexible foil shaped kites in accordance with one embodiment of the present invention;

FIG. 4 is a representative top-side view of an array of flexible foil shaped kites in accordance with one embodiment of the present invention.

FIG. 5 is a representative top perspective view of a single flexible foil shaped kite in accordance with one embodiment of the present invention;

FIG. 6 is a representative top view of a single flexible foil kite in accordance with one embodiment of the present invention;

FIG. 7 is a representative top view of a kite foil showing preferred rope diameters of rope that is sewn and held within individual pockets that run the interior length of the kite foil to provide the shape of the foil in accordance with one embodiment of the present invention;

FIG. 8 is a representative side view of a single flexible foil shaped kite showing the locations of the interior ropes of various diameters as per FIG. 7 that run the interior length of the kite foil in accordance with one embodiment of the present invention;

FIG. 9 is a representative end view of the single flexible foil kite of FIG. 8 in accordance with one embodiment of the present invention;

FIG. 10 is a representative top view of a kite foil showing preferred fabric lengths of the fabric portions that make up the outer surface portion of the kite foil in accordance with one embodiment of the present invention; and

FIG. 11 is a representative top view of a kite foil showing preferred fabric lengths of the fabric portions that surround the individual rope diameters as shown in FIG. 7 in accordance with one embodiment of the present invention.

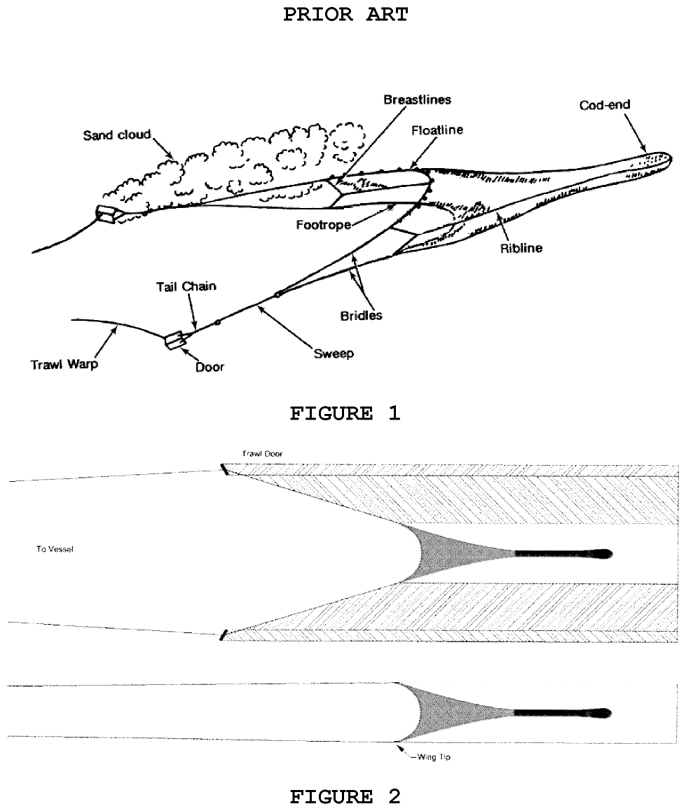

### DETAILED DESCRIPTION OF THE INVENTION

The present invention relates to an apparatus that can provide a sufficient horizontal spreading force to the mouth of a bottom trawl for herding target species into the net, while replacing traditional trawl doors with a more environmentally-friendly option that assists with lowering or minimizing negative seabed impacts, including physical alteration of the seabed, mortality of benthic animals, and suspension of sediment. In this respect, FIG. 2 provides a representative diagram comparing effects on the seabed by use of a bottom trawl employing traditional trawl doors and bridles (upper drawing) compared to that of a bottom trawl that employs the apparatus of the present invention (bottom drawing). The cross-lines shown in the upper drawing of FIG. 2 relate to the area of the seabed that is generally affected by contact with the trawl doors and bridles, and which is substantially reduced by employment of the apparatus of the present invention.

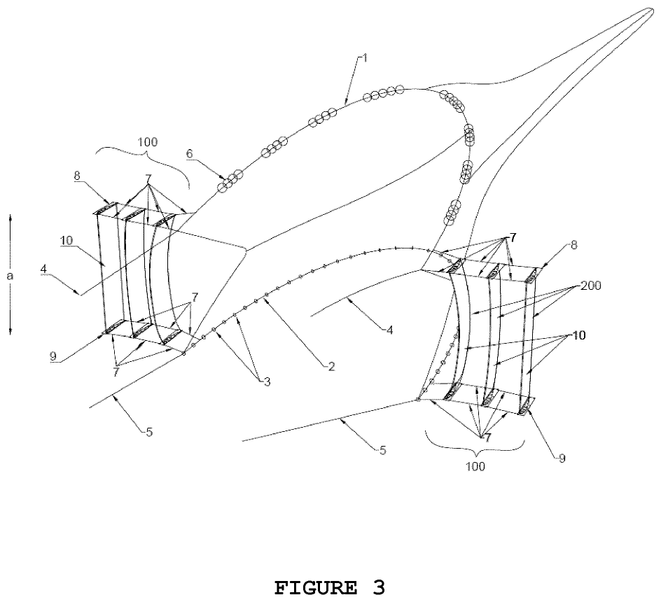

FIG. 3 provides a representative perspective view of a bottom trawl in an open operating position by means of the operation of the apparatus in accordance with one embodiment of the present invention. FIG. 3 shows the general manner in which the apparatus of the present invention is mounted/attached to a traditional trawl, which often comprises a headline 1 with floats 6 mounted thereon, and footgear 2 with rockhoppers 3 mounted thereon. The apparatus generally comprises an array 100 (i.e. at least two and preferably three or more) of flexible foil shaped kites 200 that are mounted/attached near the wings at or proximate to top bridle 4 and lower bridle 5 on each side of a bottom trawl by means of adjustment chains 7 or such similar adjustment mechanisms as would be known to persons skilled in the art.

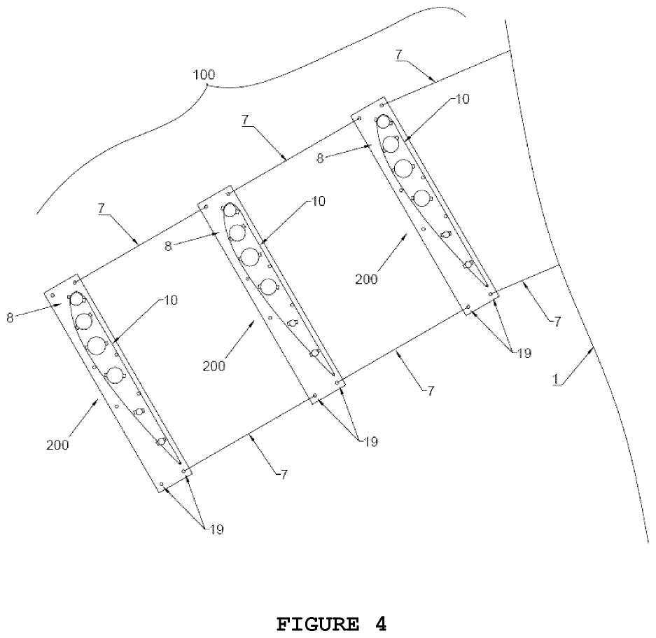

FIG. 4 provides a representative top-side view of an array 100 of flexible foil shaped kites 200 in accordance with one embodiment of the present invention. With reference to FIGS. 3 and 4, adjustment chains 7 (or such similar adjustment mechanisms as would be known to persons skilled in the art), which are preferably connected to the kites 200 via holes 19 in endplates 8 and 9 (more on the specifics of the kites 200 below), are also used to maintain the kites 200 of the array 100 at a preferred distance from one another to produce sufficient spreading force on the trawl. In this respect, it has been found that it is preferable to have the individual kites 200 spaced apart from one another approximately 1.5 times the longitudinal chord length of a kite foil 10 (see line “a” in FIGS. 3 and 8) in order to minimize negative interactions of turbulence from one kite 200 on the performance of any neighboring kite 200, although persons skilled in the art would appreciate that other such similar distances in between the kites may be similarly effective. This distance between kites 200 should preferably be the same for all kites 200 in an array 100. Moreover, it has been found that maximum lift forces on the trawl are produced when the kite array 100 is operating at a sufficiently high (˜35°) “angle of attack” (i.e. when the array 100 is attached to the top bridle 4 and lower bridle 5 on each side of the bottom trawl such that the array 100 of flexible foil shaped kites 200 is positioned overall at a sufficiently high angle (e.g. ˜35° from the forward towing direction of the trawl)).

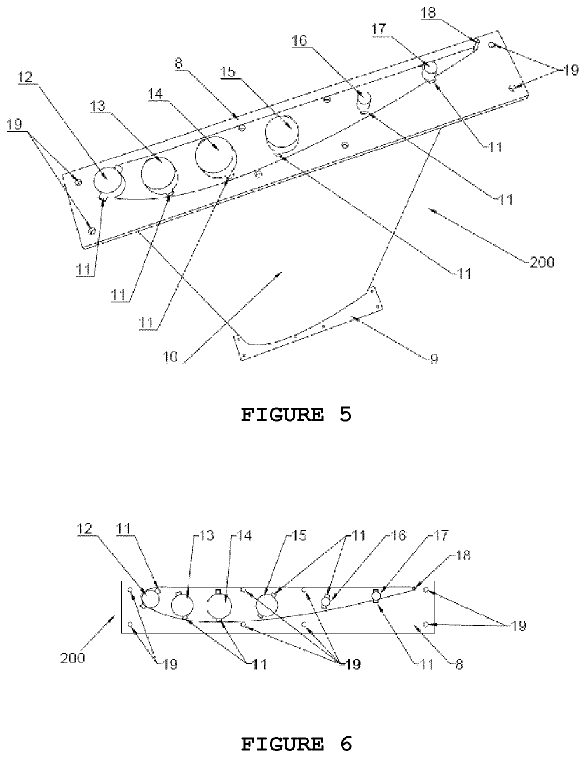

FIGS. 5 and 6 provide representative top perspective, and top views, respectively, of a single flexible foil shaped kite 200 in accordance with one embodiment of the present invention. With reference to FIGS. 3 and 5 in particular, each flexible foil shaped kite 200 comprises, in general, a kite foil 10 held between opposing top endplate 8 and bottom endplate 9, which assist in maintaining the desired shape of kite foil 10.

The kite foils 10 of the kites 200 are preferably made of a flexible material, such as vinyl or other similarly durable fabric, surrounding ropes 12 to 18 (or wires, or the like, as would be known to persons skilled in the art), of various diameters that are stably housed within individually sewn pockets in the kite foil 10 to keep them in order and to provide the kite foil 10 with a particular shape. In this respect, it has been found that sufficient spread of the trawl may be provided by a foil 10 having an outer profile shape that approximates a National Advisory Committee for Aeronautics (NACA) 5314 shape (see, in particular, FIGS. 4, 7, 10, and 11), although persons skilled in the art would appreciate that other such similar shapes may also provide the necessary spreading force.

The ropes 12 to 18 (or wires, or the like) of kite foils 10 extend through endplates 8 and 9, and are preferably secured therethrough via 9/16″ diameter locking pins, but may be secured by any other manner deemed appropriate by a person skilled in the art. Endplates 8 and 9 are preferably comprised of a rigid material, such as high density plastic, but they are preferably made from steel.

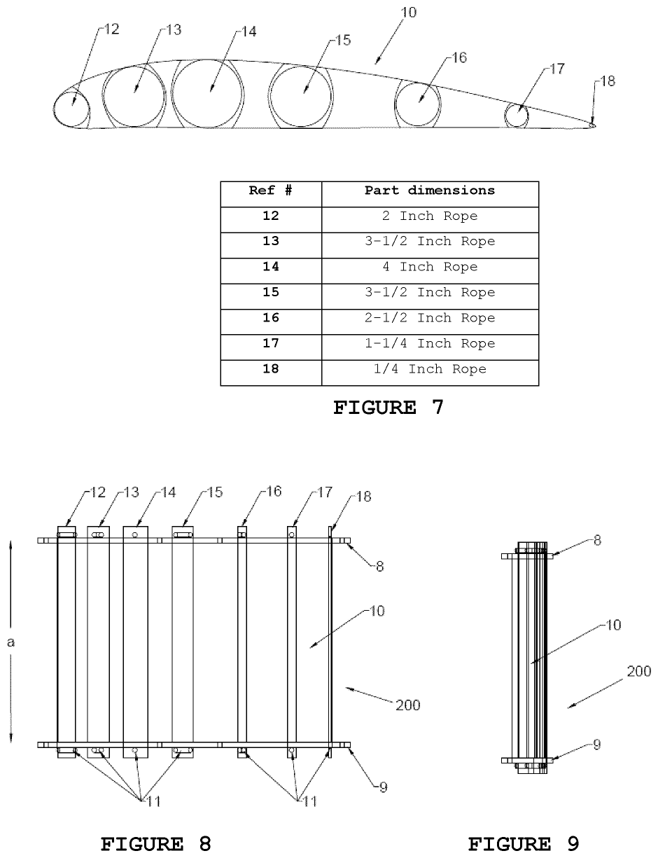

FIG. 7 provides a representative top view of a kite foil 10 showing preferred diameters in the included Table of rope 12 to 18 (or wires, or the like) that is housed within the individually sewn pockets that run the interior length of the kite foil 10 (as further shown by the side and end views of foil 10 in FIGS. 8 and 9, respectively) to provide the shape of the foil as discussed above, in accordance with one embodiment of the present invention.

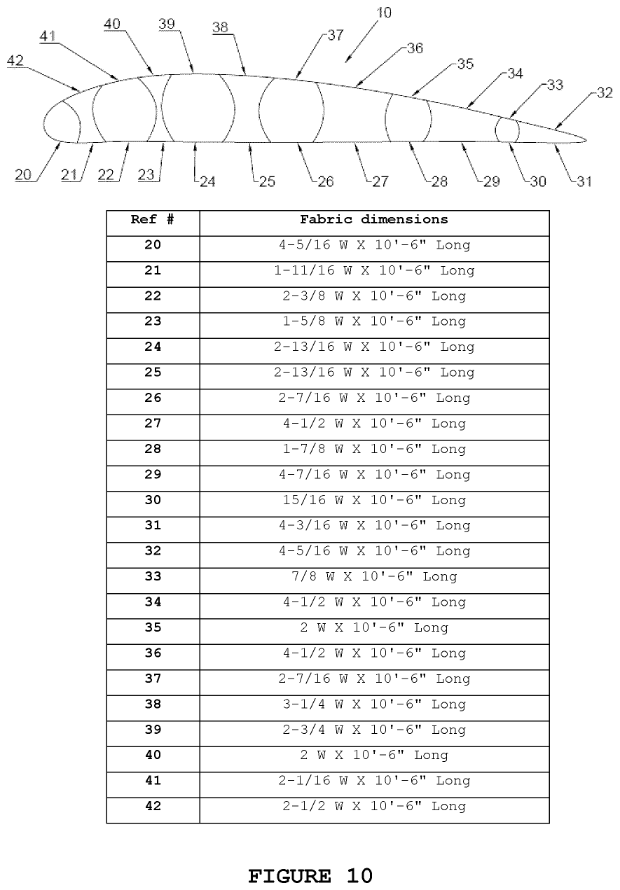

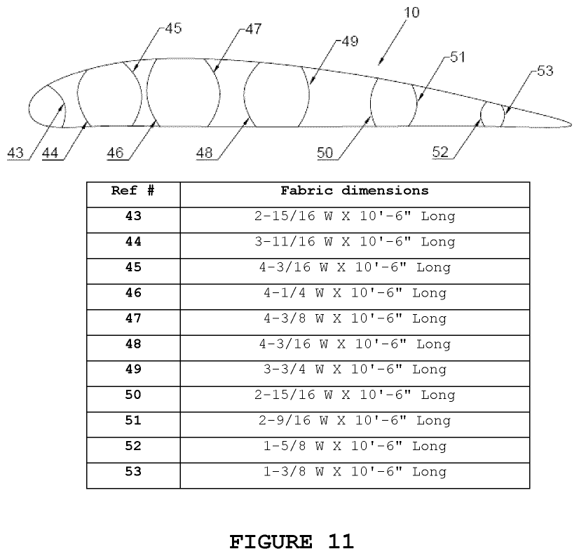

For ease of producing a preferred embodiment of the present invention, FIG. 10 provides a representative top view of a kite foil 10 showing preferred material/fabric lengths of material/fabric portions 20 to 42 that may comprise the outer surface portion of the kite foil 10 in accordance with one embodiment of the present invention. Alternatively, the outer surface portion of the kite foil 10 may comprise a single length of material/fabric, and the lengths discussed above assist with understanding the positioning of the rope 12 to 18 (or wires, or the like) in the kite foil 10. In addition, FIG. 11 provides a representative top view of a kite foil 10 showing preferred material/fabric lengths of material/fabric portions 43 to 53 that may substantially surround the individual rope diameters of rope 12 to 18 (or wires, or the like) as shown in FIG. 7, in accordance with one embodiment of the present invention.

Because at least the kite foils 10 of the kites 200 are flexible, the skilled person may permanently attach the array 100 of kites 200 to the trawl itself, where they can even be wound with the trawl onto a netdrum (not shown) on the stern of a vessel for general ease of storage and release.

Although specific embodiments of the invention have been described, it will be apparent to one skilled in the art that variations and modifications to the embodiments may be made within the scope of the following claims.

We claim:

1. A flexible foil shaped kite for use in spreading the mouth of a bottom trawl, said kite comprising:
a middle kite foil section having an outer profile shape that is capable of assisting in spreading the mouth of the bottom trawl when in use, and having pockets extending longitudinally therethrough that house rope or wire of varying diameter, and
a first and second endplate attached at each of a first and second distal end of the middle kite foil section respectively for maintaining a desired rigidity of the kite foil section, said first and second endplates having openings therethrough in communication with the pockets of the middle kite foil section, such that the rope or wire of varying diameter securely extends through said openings in the first and second endplate.

2. The flexible foil shaped kite of claim 1 wherein the outer profile shape of said kite foil section is substantially a NACA 5314 shape.

3. The flexible foil shaped kite of claim 2 wherein the middle kite foil section is comprised of vinyl.

4. The flexible foil shaped kite of claim 3 wherein the first and second endplates are comprised of steel.

5. The flexible foil shaped kite of any one of claims 1 to 4 wherein said kite is capable of being wound with the bottom trawl onto a netdrum on a stern of a vessel.

6. An apparatus for spreading the mouth of a bottom trawl comprising,
an array of flexible foil shaped kites that is capable of being mounted proximate to a wing of the bottom trawl, and wherein each of the kites in the array of flexible foil shaped kites has the same chord length and comprises:
a middle kite foil section having an outer profile shape that is capable of assisting in spreading the mouth of the bottom trawl when in use, and having pockets extending longitudinally therethrough that house rope or wire of varying diameter, and
a first and second endplate attached at each of a first and second distal end of the middle kite foil section respectively for maintaining a desired rigidity of the kite foil section, said first and second endplates having openings therethrough in communication with the pockets of the middle kite foil section, such that the rope or wire of varying diameter securely extends through said openings in the first and second endplate.

7. The apparatus of claim 6 wherein the outer profile shape of the kite foil sections of the kites in the array of flexible foil shaped kites are all substantially of a NACA 5314 shape.

8. The apparatus of claim 7 wherein the middle kite foil section of each of the kites in the array of flexible foil shaped kites is comprised of vinyl.

9. The apparatus of claim 8 wherein the first and second endplates of each of the kites in the array of flexible foil shaped kites are comprised of steel.

10. The apparatus of claim 7, wherein the kites in the array of flexible foil shaped kites are spaced apart at a distance of about 1.5 times the chord length of the kites.

11. The apparatus of claim 10, wherein the kites in the array of flexible foil shaped kites are oriented at a 35 degree angle of attack to a forward towing direction of the trawl.

12. The apparatus of any one of claims 6 to 11 wherein said apparatus is capable of being wound with the bottom trawl onto a netdrum on a stern of a vessel.

13. Use of a flexible foil shaped kite as claimed in any one of claims 1 to 5 for bottom trawling.

14. Use of an apparatus as claimed in any one of claims 6 to 12 for bottom trawling.
